(19) United States
(12) Patent Application Publication
(10) Pub. No.: US 2014/0061276 A1
(43) Pub. Date: Mar. 6, 2014

(54) Break-Off Device

(71) Applicant: Joachim Jakob, Radolfzell (DE)

(72) Inventor: Joachim Jakob, Radolfzell (DE)

(21) Appl. No.: 14/006,339

(22) PCT Filed: Mar. 22, 2012
(86) PCT No.: PCT/EP2012/055089

§ 371 Date: Nov. 18, 2013

(30) Foreign Application Priority Data
Mar. 22, 2011 (DE) 10 2011 001 477.2

(51) Int. Cl. B26D 7/18

(52) U.S. Cl. CPC B26D 7/1818
USPC 225/93

(57) ABSTRACT

The invention relates to a break-off device comprising a break-off pin (1) with a base (4), a head (5), and an upper break-off plate (2) that has a thickness (D) of 15 mm. The break-off pin (1) should have a length (L) of 48 mm.

### TECHNICAL FIELD

The present invention generally relates to a break-off device comprising a break-off pin for being mounted to a break-off plate.

### BACKGROUND

Devices are known from the prior art for breaking pre-cut parts out of stamped sheets. These comprise an upper break-off tool having a break-off plate and a break-off pin, and a lower break-off tool having supporting surfaces and holes through which the part that has been broken off can fall.

In the year 1989, the leading manufacturer of break-off plates for the upper break-off tool increased the thickness of the break-off plates to 15 mm and 16 mm, respectively, for the USA. Since then, the break-off pins known from the prior art, which have an overall length of 44 mm, have been inserted at their end pieces 9 mm into the upper break-off plates, or in a hole in the upper break-off plates. As a result, there is the disadvantage that the plates have become more expensive, heavier and thicker, thus requiring more space. Moreover, it is disadvantageous that for the break-off device, no substantial improvements have been obtained through the use of thicker plates.

### SUMMARY OF THE INVENTION

The objective of the present invention is to create an improved break-off device, in which the break-off pin is reliably held in place. A break-off pin having a length of about 45 mm to about 50 mm, preferably about 48 mm, leads to a solution for this objective.

A break-off device preferably comprises an upper break-off plate having a thickness of 15 mm, and a break-off pin having a base and a head. Preferably, the break-off plate consists of wood. It is particularly preferred that a part of the base of the break-off pin is inserted in the break-off plate, or a hole in the break-off plate. It is particularly preferred that the break-off pin be 45 mm 50 mm long, preferably 48 mm. As a result, the advantage is obtained that better use can be made of the greater plate thickness used for the previous 22 years.

In typical exemplary embodiments, the break-off pin comprises a mounting part. The mounting part means is the part of the break-off pin that is inserted into the upper break-off plate. Ideally, the mounting part has a insertion length of 12 mm 14 mm, preferably 13 mm. As a result, the advantage is obtained that the break-off pin according to the invention is inserted with a longer mounting part into the break-off plate, or a hole in the break-off plate, respectively, than break-off pins known from the prior art. As a result of the greater overall length of the break-off pin, the advantage is obtained that the break-off pin can be inserted with a longer part into the break-off plate, and still exhibit the correct working length. As a result of the break-off pin being inserted with a longer section into the break-off plate, the further advantage is obtained that the break-off pin is better and more reliably inserted, and thus held in place more precisely.

Ideally, the mounting part comprises numerous cuttings (e.g., notches). Preferably, the cuttings run about the circumference in the radial direction. It is particularly preferred that the cuttings are disposed such that they are basically (e.g., substantially) perpendicular to a central axis of the break-off pin. It is particularly preferred that the mounting part comprises four cuttings. As a result of the cuttings in the mounting part of the base of the break-off pin, the break-off pin is advantageously more reliably anchored in the break-off plate, because the cuttings function in the manner of a barbed toothing. It is furthermore advantageous that, for the break-off pin according to the invention, due to its longer mounting part, more cuttings can be made than with the shorting break-off pins according to the prior art.

Ideally, the base has a length of 23 mm 28 mm, preferably 25 mm. It is particularly preferable that the head of the break-off pin has a smaller diameter than the base of the break-off pin. As a result, a shoulder is formed between the head and the base. As a result of the modified advantageous lengths of the head and the base, the shoulder is advantageously disposed at a higher position than with break-off pins according to the prior art. As a result, the advantage is obtained that the shoulder of the break-off pin does not come into contact with the workpiece, or its surface, during the breaking off. As a result, damage to the surface of the workpiece is prevented, or the surface of the workpiece is not “stamped” by the shoulder.

In typical exemplary embodiments, the break-off pin comprises a bevel on its base, at the upper end. Preferably, the bevel has a length of 3 mm, and a preferred angle of 45°. As a result, the break-off pin according to the invention has a straighter seating in the break-off plate as compared to conventional break-off pins having longer bevels. This advantage is obtained because the mounting part inserted into the break-off plate is cylindrical over a greater length, and is better suited for the insertion of the break-off pin. Furthermore, it is advantageous that the break-off pin according to the invention, having the shorter bevel, and thus a shorter tapering, can less readily be forced out of the wood functioning as the break-off plate. Furthermore, a break-off pin having a shorter bevel can be inserted in the wood of the break-off plate in a more controlled manner, and has a better contact and seating in the wood.

### BRIEF DESCRIPTION OF THE DRAWINGS

In the following, the invention shall be described using the attached figures, wherein the figures show:

FIG. 1 shows a schematic depiction of a front view of a break-off pin according to the prior art, in an upper break-off plate;

FIG. 2 shows a schematic depiction of a front view of a break-off pin according to the invention, in an upper break-off plate;

FIG. 3 shows a schematic depiction of a front view of a break-off pin according to the prior art, in a working position;

FIG. 4 shows a schematic depiction of a front view of a break-off pin according to the invention, in a working position; and

FIGS. 5 and 6 show a schematic depiction of other exemplary embodiments of break-off pins according to the invention.

### DETAILED DESCRIPTION OF EXEMPLARY EMBODIMENTS

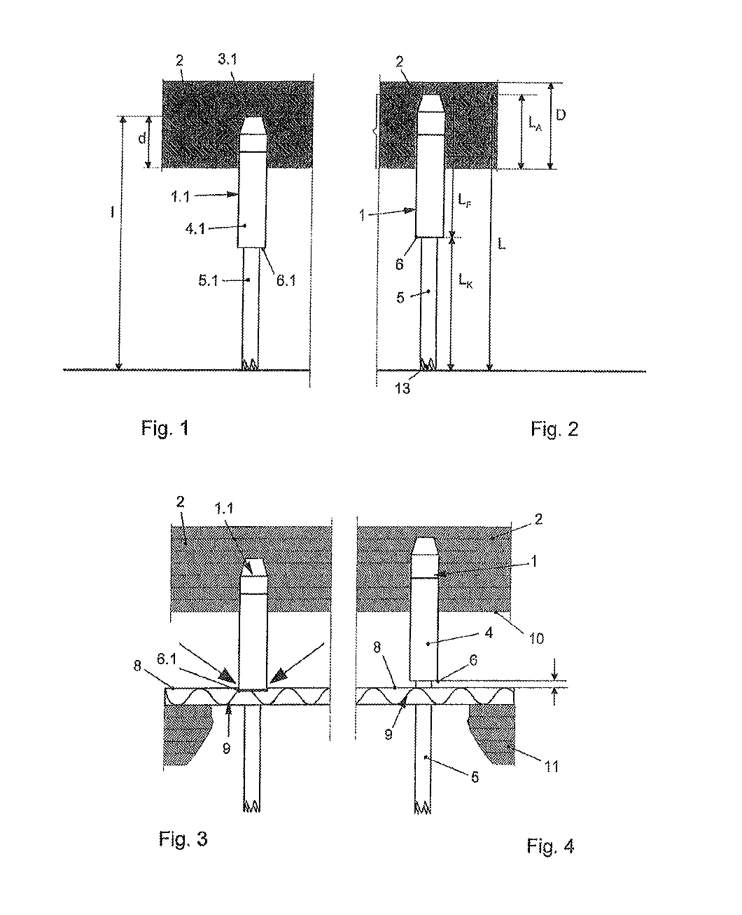

FIG. 1 shows a break-off pin 1.1 according to the prior art, in an upper break-off plate 2. The upper break-off plate 2 has a thickness D of 15 mm. In the year 1989, thus over 20 years before the application date for the present application, the thickness D of the break-off plate 2 was increased to 15 mm.

The break-off pin 11 according to the prior art has a length 1 of 44 mm, and is inserted at a length d of 9 mm, measured from a back end 3.1 of the break-off pin 1.1, into the break-off plate 2. The break-off pin 1.1 comprises a base 4.1 and a head 5.1.

In the following, the part of the break-off pin that is inserted into the upper break-off plate is referred to as the base. The part of the break-off pin that comes in contact with the workpiece is referred to as the head.

The head 5.1 has a smaller diameter than the base 4.1. As a result, the base 4.1 and the head 5.1 form a shoulder 6.1 between them.

FIG. 2 shows a break-off pin 1 according to the invention. The break-off pin 1 comprises a head 5 and a base 4. The head 5 has a smaller diameter than the base 4. The base 4 and the head 5 form a shoulder 6 between them. The new break-off pin 1 has a length L of 48 mm. The base 4 of the break-off pin 1 according to the invention comprises a mounting part 13. The mounting part 13 of the break-off pin 1 is the part of the base 4 that is inserted into the break-off plate 2. The mounting part 13 has an insertion length L_{A} of 13 mm. As a result, the advantage is obtained that the break-off pin 1 is better and more reliably inserted in the break-off plate 2 than the break-off pin 1.1, which is inserted with a length d of only 9 mm in the break-off plate 2.

The base 4 has a base length L_{F} of 25 mm. The head 5 of the break-off pin 1 has a head length L_{K} of 23 mm. The shoulder 6 is formed at a distance L_{K} of 23 mm from a front tip 7 of the break-off pin 1.

FIG. 3 shows a break-off pin 1.1 according to the prior art, and FIG. 4 shows a break-off pin 1 according to the invention, during the breaking off of a pre-cut part. Both break-off pins 1 and 1.1 are inserted in a break-off plate 2. A workpiece 9, in particular a stamped sheet, lies on a lower break-off tool 11.

In comparing the FIGS. 3 and 4, another advantage of the break-off pin 1 according to the invention becomes clear.

With a conventional break-off pin 1.1 according to FIG. 3, the shoulder 6.1 lies on a surface 8 of a workpiece 9 during the breaking off. As a result, there is the disadvantage that the edges or surfaces of the shoulder 6.1 leave imprints on the surface 8 of the workpiece 9 (so-called stamping effect). This stamping effect does not occur with the break-off pin 1 according to the invention, as depicted in FIG. 4. Because the shoulder 6 lies at a shorter distance from the underside 10 of the break-off plate 2, it does not come into contact with the surface 8 of the workpiece 9. As a result, the shoulder 6 does not leave an imprint on the surface 8 of the workpiece 9.

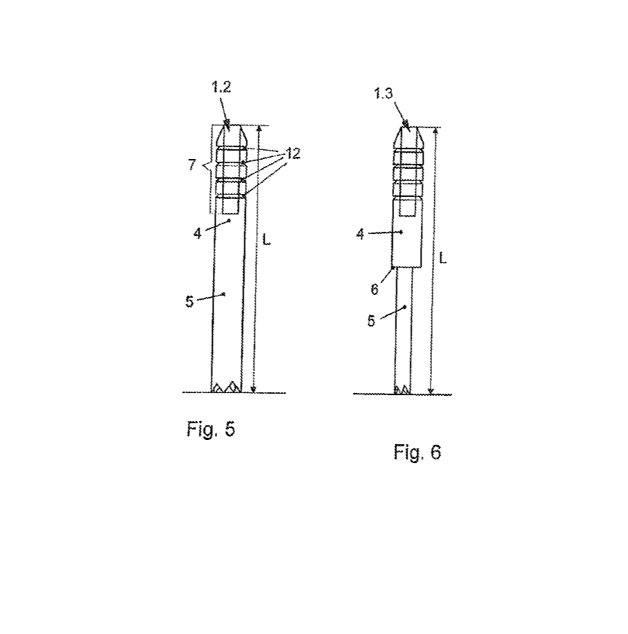

FIG. 5 shows another exemplary embodiment of a break-off pin 1.2 according to the invention, having a length L of 48 mm. With this break-off pin 1.2, the base 4 and the head 5 have the same diameter. Furthermore, the break-off pin 1.2 comprises in its base 4, in particular in its mounting part 13, numerous cuttings 12 (e.g., notches). In the exemplary embodiment of FIG. 5, the mounting part 13 comprises four cuttings 12. The cuttings 12 are designed as recesses, wherein the recesses are perpendicular to a central axis of the break-off pin, running radially about the circumference. By means of the cuttings 12, the effect is obtained that the mounting part 13 engages in the break-off plate 2 in the manner of a barbed toothing.

FIG. 6 shows another exemplary embodiment of a break-off pin 1.3. The break-off pin 1.3 also exhibits a length L of 48 mm, in accordance with the invention. Analogously to the break-off pin 1.2, the break-off pin 1.3 according to the invention also comprises numerous cuttings 12 in its base 4. In the exemplary embodiment of FIG. 6, the head 5 of the break-off pin 1.3 has a smaller diameter than the base 4, such that they form the shoulder 6.

1. A break-off device, comprising:
a break-off pin comprising a base and a head, and
an upper break-off plate to which the break-off pin is mounted, wherein the upper break-off plate has a thickness of about 15 mm,
wherein the break-off pin has a length of about 45 mm to about 50 mm.

2. The device according to claim 1, wherein:
the break-off pin comprises a mounting part,
the mounting part is inserted in the upper break-off plate, and
the mounting part has an insertion length of about 12 mm to about 14 mm.

3. The device according to claim 2, wherein the mounting part comprises a plurality of notches oriented substantially perpendicularly to a central axis of the mounting part.

4. The device according to claim 1, wherein the base has a length of about 25 mm.

5. The device according to claim 1, wherein the head has a length of about 23 mm.

6. The device according to claim 1, wherein the head has a smaller diameter than the base, so that the break-off pin has a shoulder positioned between the head and the base.

7. The device according to claim 1, wherein the base comprises a bevel at an upper end of the base, and the bevel has a length of about 2 mm to about 4 mm.

8. (canceled)

9. The device according to claim 1, wherein the break-off pin has a length of about 48 mm.

10. The device according to claim 2, wherein the mounting part has an insertion length of about 13 mm.

11. The device according to claim 3, wherein the plurality of notches comprises four notches.

12. The device according to claim 7, wherein the bevel has a length of about 3 mm.

13. The device according to claim 3, wherein the base has a length of about 25 mm.

14. The device according to claim 13, wherein the head has a length of about 23 mm.

15. The device according to claim 14, wherein the head has a smaller diameter than the base, so that the break-off pin has a shoulder positioned between the head and the base.

16. The device according to claim 14, wherein the base comprises a bevel at an upper end of the base, and the bevel has a length of about 2 mm to about 4 mm.

17. A break-off device, comprising:
an upper break-off plate having a thickness of about 15 mm;
a break-off pin having a length of about 45 mm to about 50 mm;
the break-off pin being mounted to the break-off plate, comprising
a base of the break-off pin comprising a mounting part that extends about 12 mm to about 14 mm into a hole of the break-off plate,
the base comprising a bevel at an upper end of the base, wherein the bevel is positioned in the hole of the break-off plate, and
the mounting part comprising a plurality of notches positioned below the bevel, wherein the notches are positioned in the hole of the break-off plate, and the notches extend substantially perpendicularly to a central axis of the mounting part.

18. A break-off pin for a break-off device, the break-off pin comprising:
a base, and
a head,
wherein the break-off pin has a length of about 45 mm to about 50 mm.

19. The pin according to claim 18, comprising a mounting part for being inserted into an upper break-off plate, wherein the mounting part comprises a plurality of notches oriented substantially perpendicularly to a central axis of the mounting part.

20. The pin according to claim 18, further comprising a shoulder positioned between the head and the base, wherein:
the head has a smaller diameter than the base,
the base has a length of about 25 mm, and
the head has a length of about 23 mm.

21. The pin according to claim 18, wherein the base comprises a bevel at an upper end of the base, and the bevel has a length of about 2 mm to about 4 mm.
